(19) United States
(12) Patent Application Publication
(10) Pub. No.: US 2022/0307239 A1
(43) Pub. Date: Sep. 29, 2022

(54) MOON WATER: THE METHOD OF COLLECTING OR SETTING WATER UNDER THE MOONLIGHT ACCORDING TO ANY CALENDAR SIGNIFICANCE

(71) Applicant: Juhl T Helias, South Jordan, UT (US)

(72) Inventor: Juhl T Helias, South Jordan, UT (US)

(21) Appl. No.: 17/211,795

(22) Filed: Mar. 24, 2021

(51) Int. Cl. E03B 3/04; G04B 19/26; E03B 3/02; E03B 3/30; G09B 27/00

(52) U.S. Cl. CPC E03B 3/04; G04B 19/268; E03B 3/02; E03B 3/30; G09B 27/00

(57) ABSTRACT

The present invention relates to collection of water after being exposed to the moonlight. The water resource for exposure under moonlight over any period of time and the storage of such collected water so obtained from any resource. The water resource collected and composed of but not limited to collection of water from resources like river, spring, rain, snow, well water, tap water, distilled bottled water, that is accumulated. The period during which water is exposed to the moonlight can have a combination of significance but not limited to: zodiac, religious, astronomical, calendar, astrological, numerology etc. Further, the exposed water obtained is packed and labeled based on the religious, astronomical, astrological, numerological significance classified or falling under the time when the water resource or the water stored in the container is exposed to the source of moonlight. The water resource collected and composed of but not limited to collection of water from resources like river, spring, rain, snow, tap water, dew, distilled bottled water, well water that is accumulated or placed.

### TECHNICAL FIELD OF THE INVENTION

The present invention relates to the procedural method of collection of water after being exposed under the different phases of moonlight such as but not limited to new and full moons. The water resource is used under the different phases of moonlight and is stored over a period of time can be obtained from any water resource.

### FIELD OF INVENTION

The invention is directed to water exposure under all phases of the moonlight and in particular to the process of collecting, storing, interpreting, and labeling for commercialization.

### BACKGROUND OF THE INVENTION

Water resources when exposed under the different phases of moonlight over any period of time have elemental value. In the prior art there are no such methods mentioned wherein the water resource exposed to the moonlight is stored, packed, interpreted and labeled in accordance to the time of collection.

### SUMMARY OF DISCLOSURE

The present invention relates to the procedural method of collection of water after being exposed under the different phases of moonlight. The water resource is obtained under the different phases of moonlight over any period of time and storing of such collected water is so obtained from any water resource.

In one of the embodiments, the water collected consisted of but not limited to water from resources such as tap water, distilled bottle water, river, spring, rain, lake, dew, snow, and water accumulated from a well.

And further, the period during which water is exposed under all phases of the moonlight and in combination of astrological significance but not limited to zodiac including Western and Eastern versions, calendar, numerology, religious and so on and so forth. Further, the exposed water so obtained is packed and labeled based on the interpretation of astrological significance, numerological significance, or religious significance so classified or falling under the time when the water resource or the water stored in the container is exposed under the different phases of the moonlight.

The water when exposed to the moonlight during any phase of the moon light has elemental significance. The significance of the elemental properties increases further when the moon light falls under astrological, astronomical, numerological, religious significance or other calendar events. Such elemental water when kept, stored, or served is of great importance.

procedural method of making moon water has following steps:
1. Step 1, comprises placing tap or distilled bottled water or collecting, rain, dew, snow or sometimes well water that fell during or accumulated under the different phases of the moon.
2. Step 2, comprises further interpreting the astrology, astronomical, religious, calendar or numerology of the now collected water under the phase of the moonlight.
3. Step 3, the water exposed to the moonlight is further labeled followed by the interpretation and significance based on the astrological values, astronomical values, religious values, numerological values or calendar value of any container.
4. Step 4, involves the selling of packed composition obtained from Step 3.

In one of the embodiments, procedural method relates to exposed water to the moon light collected in combination with a list comprising but not limited to specific astrological date, astronomical date, religious date, numerology date, calendar date, zodiac date, and or solar date.

Further, in one of the embodiments comprises collection of the exposed water in the presence of moonlight correlates with days of significant astrology, numerology, religious, zodiac, astronomical events and moon phases of any kind or calendar events. And labeling with significance and interpretation of the said composition so obtained.

In one of the embodiments the present invention relates to water in the pure form or in combination of ingredients or in part comprising of essential oils, such as but not limited to flowers such as Bach flower essences, gemstones, tinctures, holy water, or essential oils, or other natural sources to enhance the elemental value of water.

In one of the embodiments, a method of procedural application comprising exposure of water resources consisting of but not limited to rainwater, snow water, dew water, tap water, well water, spring water and distilled bottled water.

### DETAILED DESCRIPTION

The present invention relates to the procedural method of collection of water after being exposed under the moon. The water resource used for exposing under the different phases of the moon over a period of time and storing such collected water resources.

Water is a valuable natural resource that is found in different forms in the environment. It is important to understand how water moves through the environment so that we can understand how to manage it successfully. Fresh water is finite and vulnerable. Resources of water are not limited to oceans, glaciers, ground water, permafrost, freshwater, soil moisture, atmospheric dew, wetlands, rivers, ponds, well, and lakes etc.

In one of the embodiments, the water resource for exposure under moonlight more specifically comprises but is not limited to collection of water from resources like river, spring, rain, snow, lake, well water that is accumulated or tap water or bottled distilled water.

And further, the period during which water is exposed to the different phases of the moon can have a combination of astrological significance but not limited to the zodiac, calendar events, numerology, religion, astronomy, etc. Further, the exposed water so obtained is packed and labeled based on the astrological, numerological, religious, astronomical, or zodiac falling under the time when the water resource or the water stored in the container is exposed to the source of moonlight.

In the embodiments of the types of calendars around the world, but are not limited to the following: the Gregorian Calendar, Explaining the Roman months, Hijri Calendar or Islamic Calendar, The Chinese Lunar, Traditional Moon Calendars, Hebrew or Jewish Calendar, Celtic Calendar, Numerology Calendar, The cycle of 60 years, Hindu Calendar and The Hindu New Year.

In one of the embodiments of the present invention relates to astrological significance of signs falling on the light of the different phases of the moon during which exposure of water comprises of but is not limited to following zodiac: Aries, Taurus, Gemini, Cancer, Leo, Virgo, Libra, Scorpio, Sagittarius, Capricorn, Aquarius, and Pisces. Further, interpretation of the numerological number based on mathematical equations based on numeric value of the calendar Interpretation of religion based on religious significance such as Catholic feast days or Celtic holidays such as Spring Equinox. Astronomical events on the calendar would include but not limited to notable celestial events including meteor showers, eclipses, oppositions, and conjunctions.

The water when exposed to the moonlight during the different phases have elemental significance. The significance of the elemental properties increases further when the moon phase falls under astrological, astronomical, numerological, or religious significance. Such elemental water when kept or served is of great importance.

In numerology the interpretations are done based on calendar dates including but not limited to 12 individual calendar months where personal day numbers can be generated. The interpretations below the calendar are a synopsis of the tendencies or resonance most likely to be present for certain personal day numbers. The interpretations also may be consulted to determine the best personal day number for special occasions or other events or plans that have personal significance. When the number is determined, the personal day calendar can be consulted to see which days will have that personal day number.

The procedural method of making moon water has following steps:
1. Step 1, consists of placing and collecting rain, dew, snow, well water, or tap water that is placed or accumulated under any phase of the moon.
2. Step 2, comprises further interpreting the Astrology, Zodiac, Religious, Astronomy, Numerology, or Calendar of the now collected water under the different phases.
3. Step 3, the water exposed to the moon light is further labeled with the interpretation and the significance based on the astrological values, numerological values, religious values, zodiac values, calendar values, and astronomical values of any container.
4. Step 4, involves the selling of packed composition obtained from Step 3.

In one of the embodiments, a procedural method relates to exposed water under different phases of the moonlight collected in combination with list comprising but not limited to specific religious date, zodiac date, numerology date, astrology date, calendar date, and or astronomical date.

Further, in one of the embodiments which comprises collection of the exposed said water in the presence of moonlight correlating with days of significant astrology, numerology, zodiac, religious, astronomical events and moon phase of any kind or calendar events. And labeling with significance and interpretation of the said composition so obtained.

In one of the embodiments the present invention relates to water or in combination of ingredients or part thereof comprising of vegetation, but not limited to vegetation or plants such as Bach flower essence, gemstones, tinctures, essential oils, holy water, or other natural sources to enhance the elemental value of water.

The list of essential oils that may be used and are not limited to the following: Basil, Bergamot, Blue Tansy, Cinnamon Bark, Clove, Coriander, Eucalyptus, Frankincense, Geranium, Ginger, Grapefruit, Helichrysum, Lavender, Lemon, Melaleuca, Melissa, Myrrh, Oregano, Patchouli, Peppermint, Petitgrain, Rosemary, Rose, Sandalwood, Sandalwood, Spearmint, Thyme, Vetiver, Wild Orange, Wintergreen, and Ylang Ylang.

In one of the embodiments, a method of procedural application comprises exposure of water resources consisting of but not limited to rainwater, snow water, dew water, tap water, well water, spring water, and purchased distilled water.

What is claimed is:

1. A method of collection of elemental water.

2. A method of attaining elemental water after being exposed under any phase of the moon.

3. A method of claim 2, wherein the elemental water collected is exposed to moonlight for any period of time under the different moon phases.

4. The water resource collected for claim 3, is obtained from river, rain, lake, dew drops, glaciers, rivers, tap, bottled, distilled, well, snow, spring or pond.

5. The procedural method of making moon water has following steps:
i. Step 1, comprises collecting rain, dew, snow or sometimes well water that fell during any moon phase or placing tap water or bottled distilled set in moonlight during different phases of the moon.
ii. Step 2, comprises further interpreting the astrology, zodiac, religious, numerology, astronomy, or calendar of the now collected water under the phases of the moon.
iii. Step 3, the water exposed to the moonlight is further labeled followed by the interpretation and the significance based on the astrological values, numerological values, astronomical values, religious values, zodiac values, or calendar values of any container.
iv. Step 4, involves the selling of packed composition obtained from Step 3.

6. A method of labeling the interpretation of elemental water from claim 5, in any container with the phases of the moon Specimen/s.

7. A method of interpretation of claim 6, of any water type, set out on any calendar day for commercialization.

8. A method of interpretation according to claim 7, with a description correlating to days based on astrology, numerology, zodiac, religious, astronomical events, moon phase of any kind or calendar events.

9. A method of use of elemental water obtained after collecting, labeling, and interpreting based on the astronomical, astrological, religious, zodiac, numerological significance, and auspicious calendar days of significance.
